(19) United States
(12) Patent Application Publication
(10) Pub. No.: US 2013/0111727 A1
(43) Pub. Date: May 9, 2013

(54) Tissue Box Holder for Automobile

(71) Applicant: Edmond C. Eng, Kirkland, WA (US)

(72) Inventor: Edmond C. Eng, Kirkland, WA (US)

(21) Appl. No.: 13/292,083

(22) Filed: Nov. 9, 2011

(51) Int. Cl. B23P 11/00

(52) U.S. Cl. 29/428

(57) ABSTRACT

A tissue box holder for the automobile includes a planar base with side walls for the tissue box to fit within. The planar base has two legs that extend from the bottom that are adjustable to span the width of the center hump in the rear passenger compartment of an automobile, utilizing the legs to straddle and grip the center hump to prevent the tissue box holder and thus the tissue box from becoming dislodged in a moving car. The adjustable legs can be slid in or out to fit the varying widths of the center hump of various automobiles and the legs are held in a semi-permanently locked position by a series of ball and socket features integrated into the base and legs that can be overcome by force.

### CROSS-REFERENCES TO RELATED APPLICATIONS—Not Applicable

### STATEMENT REGARDING FEDERALLY SPONSORED RESEARCH OR DEVELOPMENT—Not Applicable

### THE NAMES OF THE PARTIES TO A JOINT RESEARCH AGREEMENT—Not Applicable

### INCORPORATION-BY-REFERENCE OF MATERIAL SUBMITTED ON A COMPACT DISC—Not Applicable

### BACKGROUND OF THE INVENTION

Field of Invention—The invention relates to tissue box holders and more particularly to a tissue box holder for the automobile with improved characteristics and better convenience. Facial tissues are provided in cardboard boxes in which the tissues are folded and interleaved so when one tissue is removed, another is pulled partially out of the box. Tissue boxes placed in automobiles are difficult to keep in place because of the movement of the automobile. Automobiles do not have convenient storage locations for tissue boxes similar to cup holders found in most automobiles. Tissue boxes can be tossed around in a moving car, eventually end up on the floor, crushed, dirty and eventually discarded.

Prior art for tissue box holders are not specific to automobiles or are not convenient to reach by the driver when seated. U.S. Pat. No. 7,870,983 provides a tissue box holder for the automobile that is mounted to the back of the front seats by hanging from the head rest supports. This is not convenient to reach by the driver when seated and this arrangement can take up valuable leg/knee room away from the rear passenger seated behind said tissue box holder. U.S. Pat. No. 4,967,988 is a tissue box holder requiring adhesive to permanently attach to the dash of an automobile which would be a visual impairment to driving. Accordingly it would be an advancement to the art to provide a convenient method to place a tissue box holder in an automobile that would be semi-permanent, making the location predictable to reach without searching and within reach from the driver seat without causing a visual impairment or distraction.

### BRIEF SUMMARY OF INVENTION

It is therefore one object of the invention to provide an effective tissue box holder for the automobile that remains where placed.

It is also an object of the invention to provide an effective tissue box holder that is convenient to reach from the driver seat.

It is also an object of the invention to provide an effective tissue box holder that does not create a visual impairment to driving.

It is therefore one aspect of the invention to provide a rectangular horizontal base with side walls to hold a facial tissue box with attached adjustable legs to straddle and grip the center hump (also referred to as rear hump; center hump will be used throughout this document to describe the raised center hump integrated into the floor in the rear passenger compartment of most automobiles). The two adjustable legs mounted to the rectangular base oppose each other to straddle the center hump. The opposing legs slide in and out along a rail integrated into the rectangular base to adjust to the different widths of the center humps of various automobiles. The two legs lock in semi-permanent positions to maintain the distance between the legs to fit the various widths of the center hump of automobiles.

### BRIEF DESCRIPTION OF THE SEVERAL VIEWS OF THE DRAWING(S)

FIG. 1A is an isometric view of a prior art patent (U.S. Pat. No. 7,870,983) for a tissue box holder for an automobile that is meant to be hung on the back of a seat. FIG. 1B is an isometric view of prior art patent (U.S. Pat. No. 4,967,988) for a tissue box holder with folding side walls that is meant to be secured to the dash of an automobile.

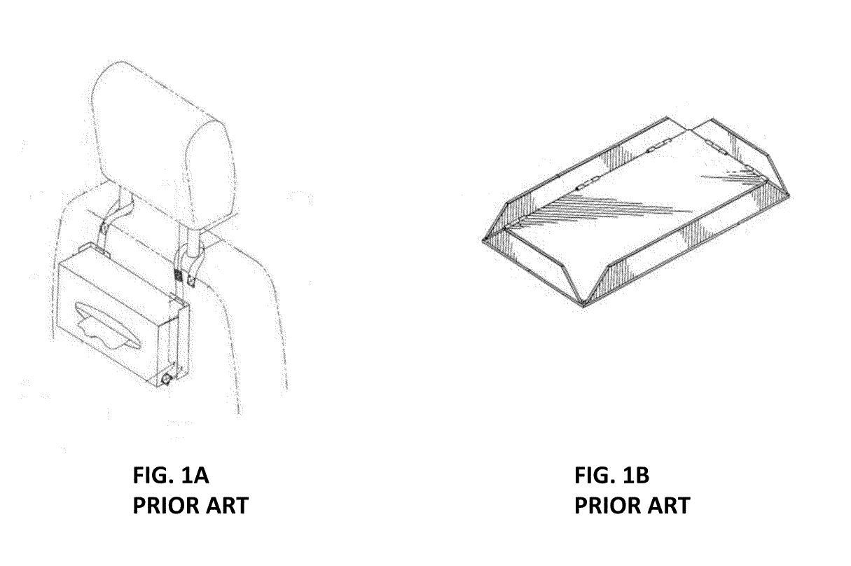

FIG. 2 is an isometric of the tissue box holder, a rectangular base with two opposing legs assembled to the base.

FIG. 3A is a top view and FIG. 3B is an isometric view of the leg showing the features of the leg that mate into the rectangular base to set the legs at the desired position.

FIG. 4 is a bottom isometric view of the rectangular base showing the integrated rail and sockets that the legs engage with to adjust the distance between the two legs.

FIG. 5 is a bottom isometric view of the rectangular base with both legs attached showing the rail integrated into the bottom side of the base with both legs attached.

FIG. 6A is a partial cutaway view of the bottom showing the two arms of the leg with the ball feature on the end of the arm that engages into the sockets of the base. FIG. 6B is an enlarged view of the engagement detail.

FIG. 7A is a plan view showing a cut line for a sectional view, FIG. 7B, showing a cross section of the leg engaged into the socket feature of the base.

FIG. 8 shows the two opposing legs adjusted for a narrow grip range shown with a cutaway view of the center hump found in the rear passenger compartment of most automobiles.

FIG. 9 is an isometric view of the tissue box holder with a tissue box placed inside the recess of the rectangular base.

FIG. 10 is a representation of a typical application of the tissue box while straddling the center hump in the rear passenger compartment.

FIG. 11 is an exploded isometric showing the base, tissue box and optional decorative cover.

### DETAILED DESCRIPTION OF THE INVENTION

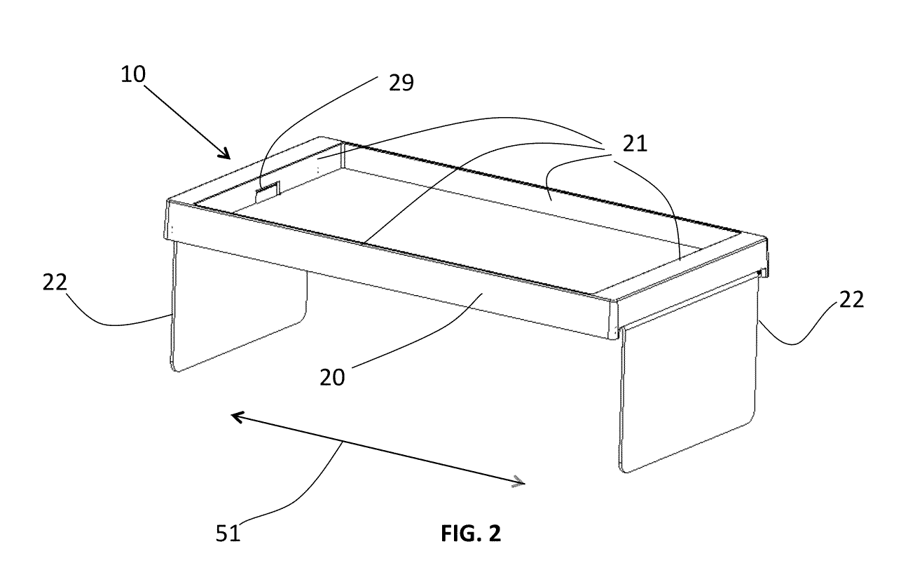

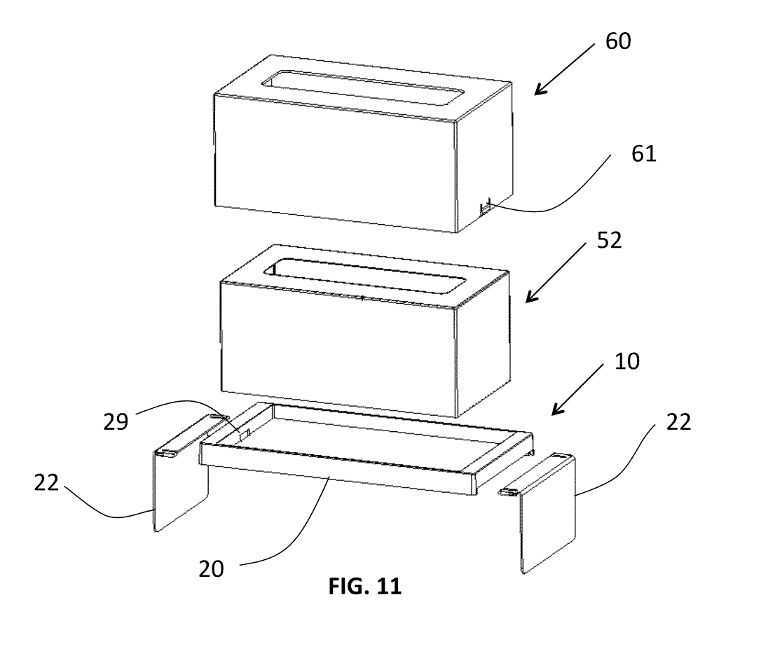

Referring to FIG. 2, in one embodiment of the invention, the tissue box holder 10 includes a rectangular base 20 with side walls 21 to hold a tissue box within the recess. The rectangular base 20 has two legs 22 attached to it, opposing each other. The two legs are able to slide in direction identified by arrows 51 to adjust the distance between the legs 22. The rectangular base 20 has an opening 29 on both ends of the base to capture an optional decorative cover shown in FIG. 11.

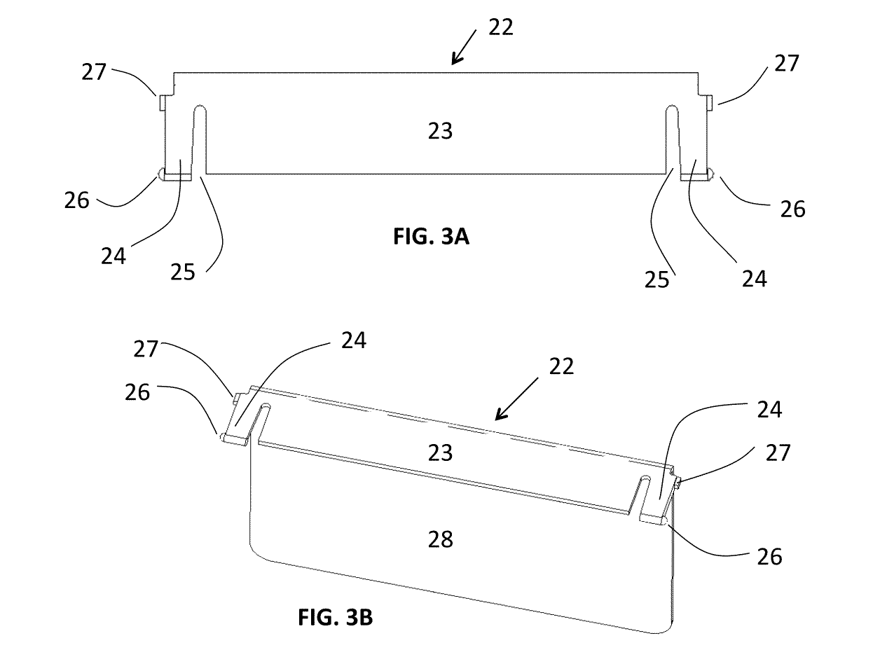

Referring to FIG. 3A, top view and FIG. 3B, isometric view of the leg 22. The leg 22 consists of a top section 23 and a side wall 28. The top section 23 has two arms 24 created by slit 25. Each arm 24 has a ball feature 26 on the end which is the engagement feature to the base. The arm 24 has another rectangular protrusion 27 on the opposite end of the arm 24 that prevents the leg from rotating when placed into the base. It is the large side wall 28 of the leg 22 that extends down from the base. The legs 22 are molded plastic.

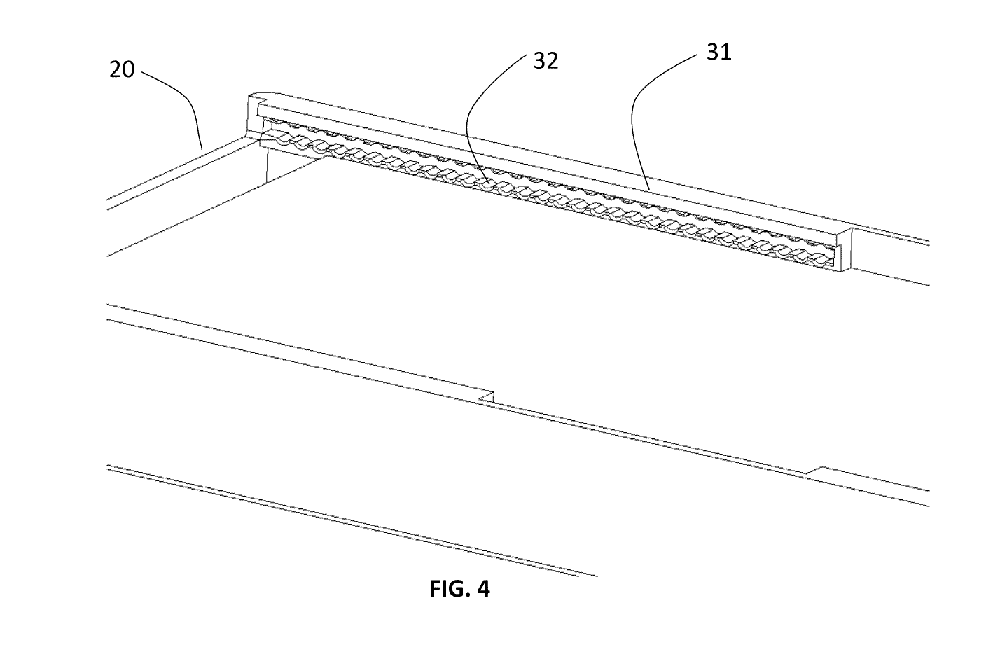

Referring to FIG. 4, includes a bottom isometric view of the multiple socket features 32 within the rail 31 of the base 20. There are rail 31 and socket features 32 on both sides of the base 20. The base 20 is a molded plastic part.

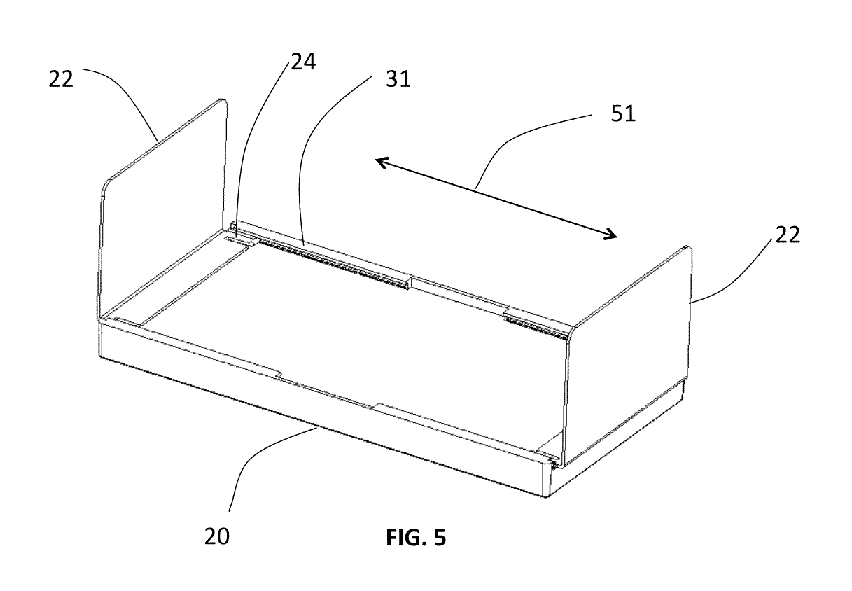

Referring to FIG. 5, includes a bottom isometric view of the rectangular base showing the integrated rail feature 31 on the bottom of the base 20 with both legs 22 installed to the base 20 with the arm 24 engaged into the rail 31. The legs 22 slide in the direction of the arrows 51 along the rail 31 of base 20.

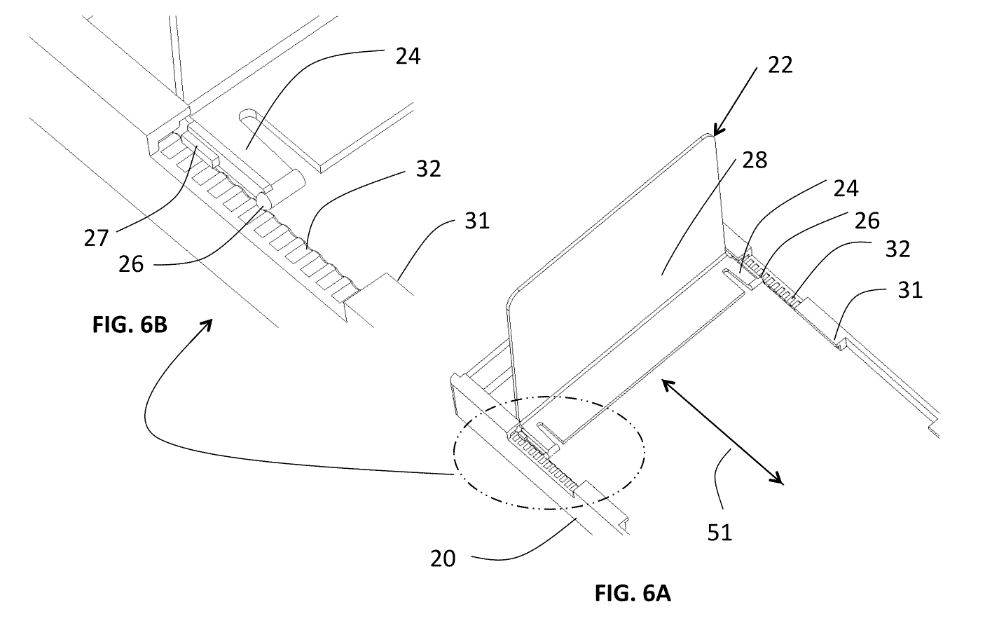

Referring to FIG. 6A and FIG. 6B, an enlarged view of a portion of FIG. 6A, includes a partial cutaway view of the rail 31 to show the multiple socket features 32 within the rail 31. The balls 26 of the arms 24 engage to the sockets 32. This ball 26 and socket 32 engagement enables the legs 22 to adjust to different widths and hold that position until purposely forced out of position. The rectangular protrusion 27 of the arm 24 fits inside the rail 31 of the base 20 to keep the leg side surface 28 generally perpendicular to the base 20.

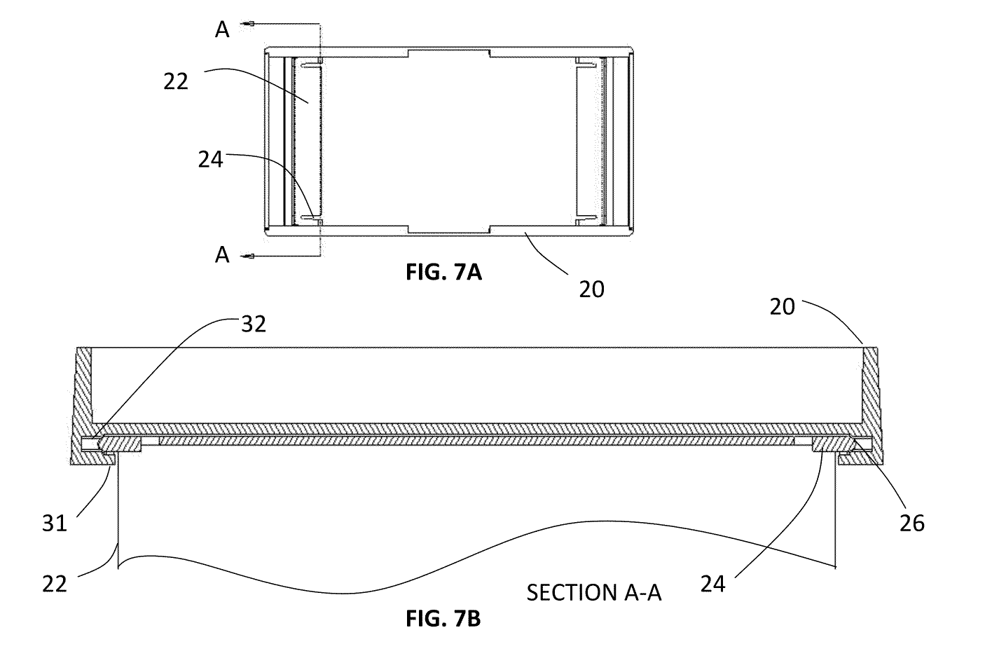

Referring to FIG. 7A, includes a bottom plan view of the base showing a cut line for a sectional view through the ball feature of the arm 24. FIG. 7B is the sectional view A-A showing the ball feature 26 of the arm engaged into the socket 32 of the base 20. The sockets 32 are within the rail 31.

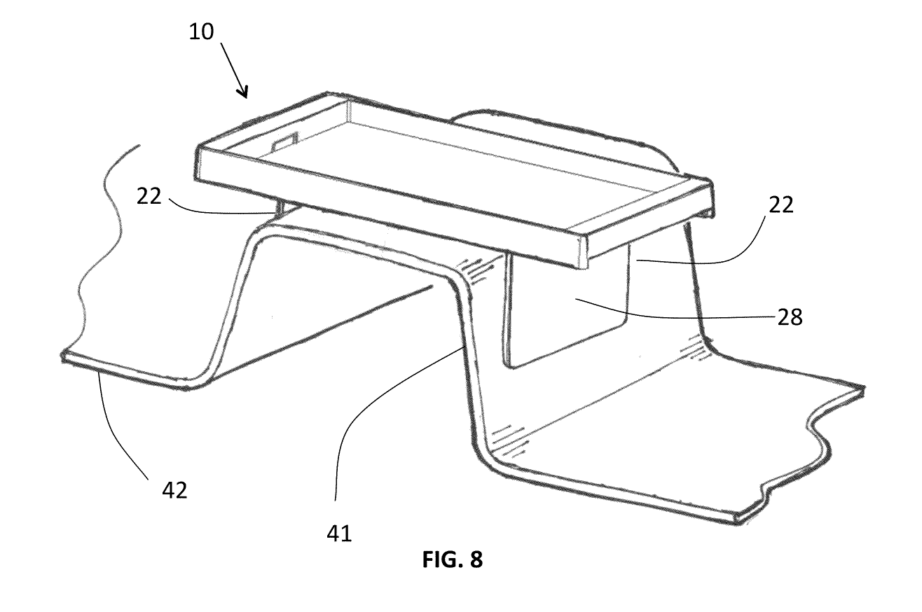

Referring to FIG. 8, while referring generally to FIGS. 2 thru 7, the function of the legs 22 will be particularly pointed out, includes the tissue box holder 10 shown on top of a center hump 41 integrated into the automobile floor 42 in cutaway view. The cutaway view shows the tissue box holder 10 with the side wall 28 of the legs 22 straddling a center hump 41. The legs 22 are shown adjusted closer together than in FIG. 2.

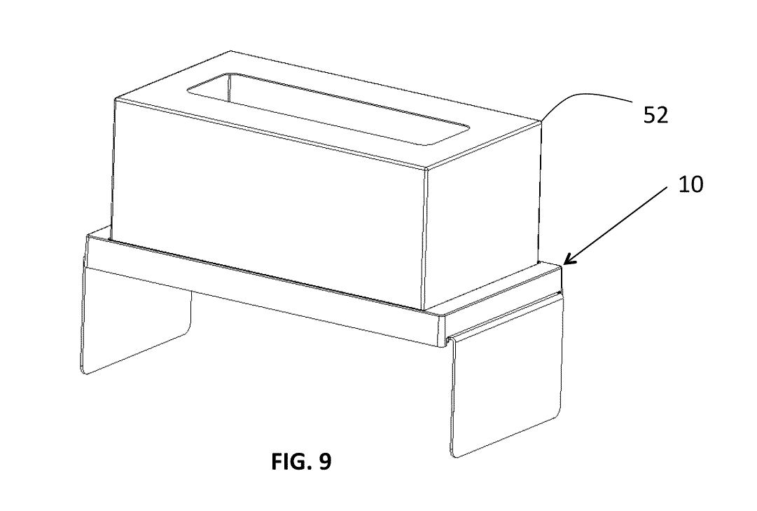

FIG. 9 is a view of the tissue box holder 10 with a tissue box 52 installed.

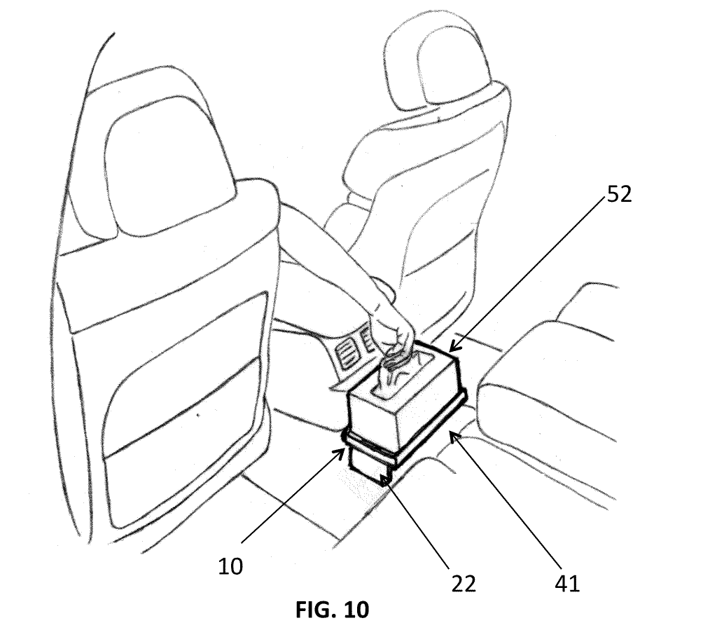

FIG. 10 is a representation of a tissue box 52 sitting in the recess of the tissue box holder 10 with the leg 22 straddling the center hump 41 in a typical application.

FIG. 11 is an exploded view of the tissue box holder 10 with base 20 and both legs 22, tissue box 52 and a decorative cover 60 that can be placed over the tissue box 52 that locks into the base 20. The decorative cover 60 is captured by fitting tabs 61 on each end into slots 29 on each end of the base 20.

While the invention herein disclosed has been described by means of specific embodiments, it is not intended that the inventions be limited thereto, as it is intended that the invention be as broad in scope as the art will allow and that the specification be read likewise. For example, the means to semi-permanently lock the legs in position by comprising a ball and socket mating, other methods to hold legs in position by detent may be employed. In another example, the base could be configured to accept a different size tissue box. It will therefore be appreciated by those skilled in the art that yet other modifications could be made to the provided invention without deviating from its spirit and scope as so claimed.

What I claim as my invention is:

1. A method to semi-permanently locate a tissue box holder in an automobile that will remain where placed and not become dislodged under normal driving conditions comprising:
A planar base with side walls for the tissue box to sit within and with legs that extend down from the base to straddle and grip the center hump found in the rear passenger compartment of most automobiles.

2. The method of claim 1, wherein the legs slide in and out along rails on the bottom of the base to adjust the distance between the legs to adjust to the different widths of the center hump of various automobiles.

3. The method of claim 1, wherein the legs are semi-permanently locked in position to maintain the distance between the legs for gripping the center hump of an automobile.

4. The method of claim 3, wherein the planar base has integrated rails on the bottom, running lengthwise along both edges, with a plurality of socket features embedded within and incrementally spaced.

5. The method of claim 3, wherein each leg includes two engagement members facing opposite directions that fit into the socket features integrated into the rails of the base that the legs will engage to semi-permanently lock in position and constrain free movement.

6. A method of claim 5, wherein the act of sliding the two legs comprises: Exerting force on the legs to overcome the frictional fit of the engagement feature of the legs from a socket to an adjacent socket of the base to increase or decrease the distance between the legs until desired width is achieved.

7. A method to place an optional decorative cover over the tissue box by semi-permanently securing it to the base using a snap fit that can be overcome by force.
